(19) United States
(12) Patent Application Publication
(10) Pub. No.: US 2025/0368836 A1
(43) Pub. Date: Dec. 4, 2025

(54) Polymer Thick Film Positive Temperature Coefficient Carbon Resistor Composition

(71) Applicant: Celanese Mercury Holdings Inc., Wilmington, DE (US)

(72) Inventors: Shufang Yu, Garnet Valley, PA (US); Hoang Tran, Wilmington, DE (US); Bradley Schickling, Wilmington, DE (US); Garrett Moran, Wilmington, DE (US); William Kampert, Wilmington, DE (US)

(21) Appl. No.: 19/189,336

(22) Filed: Apr. 25, 2025

Related U.S. Application Data
(60) Provisional application No. 63/652,700, filed on May 29, 2024.

(51) Int. Cl. C09D 5/24; C08K 3/04; C09D 7/20; C09D 7/62; C09D 127/16; H01C 7/00; H01C 7/02; H01C 17/065

(52) U.S. Cl. CPC C09D 5/24; C09D 7/20; C09D 7/62; C09D 127/16; C08K 3/04; C08K 2201/001; C08K 2201/006; H01C 7/005; H01C 7/027; H01C 17/065

(57) ABSTRACT

A polymer thick film positive temperature coefficient carbon resistor composition is provided. The composition includes an organic medium including a fluoropolymer resin and an organic solvent The composition includes a conductive carbon powder. The composition exhibits a resistivity of at least 65,000 ohm/sq/25 μm when dried for a time of about 1 minute to about 24 hours at a temperature of about 90° C. to about 210° C. Methods for forming a positive temperature coefficient circuit are also provided.

### RELATED APPLICATION

The present application is based upon and claims priority to U.S. Provisional Patent Application Ser. No. 63/652,700, having a filing date of May 29, 2024, which is incorporated herein by reference.

### BACKGROUND OF THE DISCLOSURE

Positive temperature coefficient (PTC) circuits are used as self-thermostating circuits such as in mirror heaters and seat heaters found in automobiles and the like. They are used in place of an external thermostat. Although they have been used for years in these types of applications, the PTC circuits typically have problems such as resistance shift stability, powered on/off cycling inconsistency, and sensitivity to the adhesive used in the fabrication. Such issues have a negative impact on a functional PTC circuit. Further, with emerging technologies, such as electric vehicle battery heating films, there are specific performance requirements for PTC circuits that are needed to be able to be used under high voltage (e.g., voltages exceeding 300V).

Considering this, a need exists for improved PTC materials for forming PTC circuits.

### SUMMARY OF THE DISCLOSURE

Aspects of the present disclosure are directed to a polymer thick film PTC carbon resistor composition. The composition includes an organic medium including a fluoropolymer resin and an organic solvent; and conductive carbon powder. The composition exhibits a resistivity of at least 65,000 ohm/sq/25 μm when dried for a time of about 1 minute to about 24 hours at a temperature of about 90° C. to about 210° C.

Aspects of the present disclosure are directed to a method for forming a PTC circuit. The method includes depositing a polymer thick film PTC carbon resistor composition on a substrate. The polymer thick film PTC carbon resistor composition includes an organic medium comprising a fluoropolymer resin and an organic solvent, and an oxidized carbon black. The oxidized carbon black has at least one of the following: (a) a total oxygen content of at least about 0.1 wt. % to about 15 wt. % based on the total weight of the oxidized carbon black as determined by inert gas fusion; (b) a BET surface area of about 5 m2/g to about 1500 m2/g as determined in accordance with ASTM-D6556; (c) an oil absorption number (OAN) ranging from 35 cm3/100 g to 500 cm3/100 g as determined in accordance with ASTM-D2414; or (d) has a surface area ranging from about 5 m²/g to about 750 m²/g. The method includes drying the PTC composition for a time of about 1 minute to about 60 minutes at a temperature of about 90° C. to about 210° C. to form a PTC circuit on the substrate. The PTC circuit has a resistivity of at least 65,000 ohm/sq/25 μm.

Other features and aspects of the present disclosure are set forth in greater detail below.

### BRIEF DESCRIPTION OF THE FIGURES

A full and enabling disclosure of the present disclosure, including the best mode thereof, directed to one of ordinary skill in the art, is set forth more particularly in the remainder of the specification, which makes reference to the appended figures in which:

FIG. 1 is a schematic view of an example method of forming a component arrangement according to one embodiment of the present disclosure;

FIG. 2 is a flow chart of an example method of forming a component arrangement according to one embodiment of the present disclosure;

FIG. 3 is a plan view of a silver pattern printed on a substrate according to Example 1 of the present disclosure;

FIG. 4 is a plan view of a carbon resistor pattern printed on a substrate according to Example 1 of the present disclosure;

FIG. 5 is a plan view of a silver pattern and carbon resistor pattern printed on a substrate according to Example 1 of the present disclosure;

FIG. 6 is a plan view of an example resistor design as tested according to one embodiment of the present disclosure;

FIG. 7 is a graph showing the magnification factor versus temperature for Example 1 and Comparative Example 1; and

FIG. 8 is a graph showing the magnification factor versus temperature for Example 1, Example 2, and Comparative Example 1.

Repeat use of references characters in the present specification and drawing is intended to represent same or analogous features or elements of the disclosure.

### DETAILED DESCRIPTION

It is to be understood by one of ordinary skill in the art that the present discussion is a description of exemplary embodiments only and is not intended as limiting the broader aspects of the present disclosure.

Generally speaking, the present disclosure is directed to a polymer thick film PTC carbon resistor composition. The composition includes an organic medium containing a fluoropolymer resin and an organic solvent. The composition also includes a conductive carbon powder. The composition exhibits a resistivity of at least 65,000 ohm/sq/25 μm when dried for a time of about 1 minute to about 24 hours at a temperature of about 90° C. to about 210° C.

The present disclosure is also directed to a PTC circuit. The PTC circuit is formed from a polymer thick film PTC carbon resistor composition including an organic medium containing a fluoropolymer resin and an organic solvent. The PTC carbon resistor composition also includes a conductive carbon powder. The PTC circuit has a resistivity of at least 65,000 ohm/sq/25 μm when dried for a time of about 1 minute to about 24 hours at a temperature of about 90° C. to about 210° C.

The present disclosure is also directed to articles containing a PTC circuit. The PTC circuit is formed from a polymer thick film PTC carbon resistor composition including an organic medium containing a fluoropolymer resin and an organic solvent. The PTC carbon resistor composition also includes a conductive carbon powder. The PTC circuit has a resistivity of at least 65,000 ohm/sq/25 μm when dried for a time of about 1 minute to about 24 hours at a temperature of about 90° C. to about 210° C.

The present disclosure also provides methods for forming a PTC circuit. The method includes depositing a PTC composition on a substrate. The PTC composition includes an organic medium comprising a fluoropolymer resin and an organic solvent, and an oxidized carbon black, the oxidized carbon black comprising at least one of the following: (a) a total oxygen content of at least about 0.1 wt. % to about 15 wt. % based on the total weight of the oxidized carbon black as determined by inert gas fusion; (b) a BET surface area of about 5 m²/g to about 1500 m²/g as determined in accordance with ASTM-D6556; (c) an oil absorption number (OAN) ranging from 35 cm³/100 g to 500 cm³/100 g as determined in accordance with ASTM-D2414; or (d) has a surface area ranging from about 5 m²/g to about 750 m²/g. The method includes drying the PTC carbon resistor composition forming a PTC circuit on the substrate. The PTC circuit has a resistivity of at least 65,000 ohm/sq/25 μm.

Advantageously, through selective control over the particular nature of the specific concentration of the components of the polymer thick film PTC carbon resistor composition, the present inventors have discovered that the resulting PTC circuit formed once the organic solvent is removed has a resistivity of at least 65,000 ohm/sq/25 μm, such as at least 100,000 ohm/sq/25 μm, such as at least 250,000 ohm/sq/25 μm, such as at least 500,00 ohm/sq/. High resistivity requirements are necessary in PTC circuit applications used in high voltage (e.g., voltages over 300V) applications. Thus, the polymer thick film PTC carbon resistor compositions of the present disclosure can be utilized in high voltage applications where other PTC compositions fail to meet resistivity requirements.

Various embodiments of the present disclosure will now be described in more detail.

### I. Polymer Thick Film Composition

a. Organic Medium

As indicated above, the conductive paste includes an organic medium. A polymer resin can be added to a solvent to produce an “organic medium” having suitable consistency and rheology for printing. The organic medium is suitable for dispersing solids with an adequate degree of stability. The rheological properties of the medium must be such that they lend good application properties to the composition. Such properties include dispersion of solids with an adequate degree of stability, suitable application of the composition, appropriate and relatively stable viscosity and/or thixotropy, appropriate wettability of the substrate and the solids, a good drying rate, and a dried film strength sufficient to withstand rough handling.

The organic medium includes a polymer resin that is dissolved in a solvent. The organic medium can include a polymer component. The polymer can include a fluoropolymer resin. The fluoropolymer resins should be selected to achieve good adhesion to both conductive particles dispersed therein and an underlying substrate. The fluoropolymer resin should be compatible with and not adversely affect the performance of the resulting PTC circuit.

The polymer component can include a fluoropolymer resin. As used herein the term “fluoropolymer” denotes any polymer containing in its chain at least one monomer chosen from compounds containing a vinyl group capable of opening to polymerize and which contains, directly attached to this vinyl group, at least one fluorine atom, a fluoroalkyl group or a fluoroalkoxy group.

Examples of monomers which may be mentioned include vinyl fluoride; vinylidene fluoride (VF2); trifluoroethylene (VF3); chlorotrifluoroethylene (CTFE); 1,2-difluoroethylene; tetrafluoroethylene (TFE); hexafluoropropylene (HFP); perfluoro(alkyl vinyl) ethers such as perfluoro(methyl vinyl)ether (PMVE), perfluoro(ethyl vinyl) ether (PEVE) and perfluoro(propyl vinyl)ether (PPVE); perfluoro(1,3-dioxole); perfluoro(2,2-dimethyl-1,3-dioxole) (PDD); the product of formula CF2═CFOCF2CF(CF3)OCF2CF2X in which X is SO2F, CO2H, CH2OH, CH2OCN or CH2OPO3H; the product of formula CF2═CFOCF2CF2SO2F; the product of formula F(CF2)nCH2OCF═CF2 in which n is 1, 2, 3, 4 or 5; the product of formula R1CH2OCF═CF2 in which R1 is hydrogen or F(CF2)z and z is 1, 2, 3 or 4; the product of formula R3OCF═CH2 in which R3 is F(CF2)z— and z is 1, 2, 3 or 4; perfluorobutylethylene (PFBE); 3,3,3-trifluoropropene and 2-trifluoromethyl-3,3,3-trifluoro-1-propene.

The fluoropolymer may be a homopolymer or a copolymer, and may also comprise non-fluoro monomers such as ethylene.

The fluoropolymer can be vinylidene fluoride (VF2) homopolymers and copolymers containing at least 50% by weight of VF2, the comonomer being chosen from chlorotrifluoroethylene (CTFE), hexafluoropropylene (HFP), trifluoroethylene (VF3) and tetrafluoroethylene (TFE), trifluoroethylene (VF3) homopolymers and copolymers, copolymers, and in particular terpolymers, combining residues of chlorotrifluoroethylene (CTFE), tetrafluoroethylene (TFE), hexafluoropropylene (HFP) and/or ethylene units and optionally VF2 and/or VF3 units.

In embodiments, the fluoropolymer is a copolymer of vinylidene difluoride (VF2) and hexafluoropropylene (HFP). The fluoropolymer resin (VF2/HFP) used can impart properties to the PTC composition. The copolymer of vinylidene difluoride and hexafluoropropylene helps achieve both good adhesion to both the polymer thick film conductive (e.g., silver) layer and underlying substrate and is compatible with, and thus will not adversely affect, the PTC performance. As the VF2/HFP copolymer a commercially available product can be used. Examples of VF2/HFP copolymers may include “Kynar UltraFlex B” (trade name: manufactured by Arkema) and “Kynar ADS2” (trade name: manufactured by Arkema).

In an embodiment, fluoropolymer may be about 10 wt. % to about 60 wt. %, such as about 20 wt. % to about 50 wt. %, such as about 25 wt. % to about 40 wt. % of the total weight of the organic medium.

The solvent used in the polymer thick film positive temperature coefficient carbon resistor composition can include any suitable solvent that can be removed (e.g., dried out) from the polymer thick film paste. The solvent composition can include one or more suitable solvents. Suitable solvents can include alcohols (e.g., ethanols, diols, triols, fatty acid alcohols); esters (e.g., benzoic acid esters such as dibutylphthalate, dibasic ester), glycols (e.g., butyl carbitol, dibutyl carbitol, butyl carbitol acetate, hexylene glycol); hydrocarbons or mixtures of hydrocarbons (e.g., kerosene); phosphates (e.g., trialkyl phosphates), amides (e.g., ureas), and mixtures thereof.

In embodiments, the solvent includes a trialkyl phosphate, such as triethyl phosphate. In other embodiments, the solvent includes an amide solvent, such as a diamide solvent. In embodiments, the diamide solvent can include tetramethyl urea, triethyl urea, or combinations thereof.

In embodiments, the solvent can include both a trialkyl phosphate and a diamide solvent. In such embodiments, the ratio of the trialkyl phosphate to the diamide is from about 2:1 to about 12:1, such as from about 5:1 to about 12:1, such as from about 7:1 to about 10:1.

In an embodiment, the solvent may be about 35 wt. % to about 75 wt. %, such as about 40 wt. % to about 60 wt. %, such as about 45 wt. % to about 70 wt. % of the total weight of the organic medium.

The solvent composition can optionally include one or more additives. The additives can be one or more of a thickener, stabilizer, viscosity modifier, surfactant, wetting agent, dispersant, thixotropic agent, and other conventional additives (for example colorants, preservatives, or oxidants), etc. The amount of the additive depends on the desired characteristics of the resulting conductive paste. The selected additives are not subject to limitation as long as they do not adversely affect the technical effect of the present disclosure.

The polymer thick film composition can include from about 85 wt. % to about 99 wt. %, such as from about 89 wt. % to about 96 wt. %, such as from about 90 wt. % to about 95 wt. % of the organic medium based on the total weight of the polymer thick film composition.

b. Conductive Powder

The PTC carbon resistor composition can include a conductive powder. The conductive powder can include a carbon conductive powder, such as carbon black. The conductive powder can also optionally include graphite (e.g., graphite flakes or powder) or other conductive materials such as metals (e.g., gold or silver).

In an embodiment, the conductive powder is an oxidized conductive powder. In an embodiment the conductive powder is an oxidized carbon black. As used herein, “oxidized carbon black” refers to carbon black having an appreciable number of oxygen atoms. The presence of oxygen atoms can be determined by a number of methods known in the art, such as volatile matter tests, oxygen content by inert gas fusion, or a total titratable acidic group content as determined by Boehm's titration method, as described in greater detail herein.

In one embodiment, the oxidized carbon black has a minimum oxygen content, which can determined by any method known in the art. In one embodiment, the oxidized carbon black has a total oxygen content of at least about 0.1 wt. % up to about 15 wt. % relative to the total weight of the oxidized carbon black, as determined by inert gas fusion. Total oxygen content by inert gas fusion can be determined by exposing an oxidized carbon sample to very high temperatures (e.g., about 3000° C.) under inert gas conditions. The oxygen in the sample reacts with carbon to form CO and CO₂, which can be monitored by non-dispersive infrared technique. The total oxygen content is reported in weight percent relative to the total weight of the oxidized carbon. Various oxygen analyzers based on the inert gas fusion methods are known in the art and commercially available, for example a LECO® TCH600 analyzer. In embodiments, the total oxygen content is at least about 0.1 wt. % to about 15 wt. %, such as from about 0.8 wt. % to about 13 wt. %, such as from about 1 wt. % to about 11 wt. %, such as from about 3 wt. % to about 10 wt. %, relative to the total weight of the oxidized carbon black.

In one embodiment, the oxidized carbon black has a minimum total titratable acidic group content as determined by Boehm's titration method. The Boehm titration method is a known in the art to measure the concentration of various surface acidic groups on oxidized carbons (see Boehm, H. P., Angew. Chem. 10, 669, (1964); Boehm, H. P., Carbon 32, 759 (1994); Goertzen, S. L., Carbon, 48, 1252 (2010); and Oickle, A. M., Carbon, 48, 3313 (2010)). This method is based on acid-base titration of oxidized carbons with one or more bases, e.g., three bases of different strength: NaOH, Na₂CO₃, and NaHCO₃, with the assumption that NaOH neutralizes surface carboxylic, lactonic, and phenolic groups of oxidized carbon, Na₂CO₃ neutralizes surface carboxylic and lactonic groups, whereas NaHCO₃ neutralizes only surface carboxylic groups. In one embodiment, the total titratable acidic group content is the sum of the content of carboxylic groups, lactone groups, and phenol groups as determined by Boehm's titration method. In one embodiment, the total titratable acidic group content for oxidized carbon black results from titration with NaOH in accordance with Boehm's method.

In one embodiment, the total titratable acidic group content of oxidized carbon black by Boehm's titration method is determined on a surface area basis, where BET surface area of oxidized carbon black is used. In one embodiment, the total titratable acidic group content (e.g., sum of surface carboxylic, lactone and phenols groups) is at least about 0.5 μmol/m² as determined by Boehm's titration method, such as at least about 0.7 μmol/m², such as at least about 1 μmol/m², such as at least about 1.1 μmol/m², or such as at least about 1.2 μmol/m². In embodiments, the total tritrable acidic group content is at least about 0.5 μmol/m² up to about 5 μmol/m² as determined by Boehm's titration, such as at least about 1 μmol/m² up to about 4 μmol/m², such as at least about 1.1 μmol/m² up to about 3 μmol/m² as determined by Boehm's titration method. In another embodiment, the total titratable acidic group content by Boehm's titration method is determined on a weight basis, e.g., at least about 0.5 mmol/g as determined by Boehm's titration method, such as at least about 0.7 mmol/g, at least about 1.1 mmol/g, at least about 1.2 mmol/g, at least about 1.3 mmol/g, at least about 1.4 mmol/g, or at least about 1.5 mmol/g. in embodiments, the total titratable acidic group content by Boehm's titration method is at least about 0.7 mmol/g up to about 5 mmol/g, such as at least about 1 mmol/g up to about 4 mmol/g, such as at least about 1.5 mmol/g up to about 3 mmol/g.

Generally, oxidized blacks feature a surface having oxygen-containing groups such as one or more of phenols, lactones, carbonyls, carboxylic acids, anhydrides, ethers, and quinones. The extent of oxidation of carbon black can determine the surface concentration of such oxygen-containing groups. The carbon blacks disclosed herein can be oxidized by a variety of oxidizing agents known in the art. Exemplary oxidizing agents for carbon blacks include oxygen gas, ozone, nitrogen oxides (NₓO_{y}, where x=1-2 and y=1-4, e.g., NO, NO₂, including mixtures with air), persulfates such as sodium, potassium, and ammonium persulfate, hypohalites such as sodium hypochlorite, halites, halates, or perhalates (such as sodium chlorite, sodium chlorate, or sodium perchlorate), oxidizing acids such as nitric acid, and transition metal-containing oxidants such as permanganate salts, osmium tetroxide, chromium oxides, ceric ammonium nitrates, and mixtures thereof, e.g., mixtures of gaseous oxidants such as oxygen and ozone.

Oxidation of carbon black particles is known to increase the material volatile content and total oxygen content because of the formation of various surface carbon-oxygen groups. Most of these groups convert to CO and/or CO₂ upon exposure of the oxidized carbon black to elevated temperature (such as 950° C. or higher) in the inert atmosphere. Some of the formed surface carbon-oxygen containing groups of oxidized carbon black are ionizable. The oxidized carbon black can have a volatile content ranging from about 0.1 wt. % to about 25 wt. %, such as from about 0.8 wt. % to about 20 wt. %, such as from about 1 wt. % to about 15 wt. %, such as from about 2 wt. % to about 10 wt. %, relative to the total weight of the oxidized carbon black, as determined by weight loss at 950° C.

In one embodiment, the oxidized carbon blacks have a BET surface area ranging from about 5 m²/g to about 1500 m²/g, such as from about 10 m²/g to about 1450 m²/g, from about 15 m²/g to about 1400 m²/g, from about 20 m²/g to about 1350 m²/g, from about 25 m²/g to about 1300 m²/g, from about 30 m²/g to about 1250 m²/g, from about 35 m²/g to about 1200 m²/g, from about 40 m²/g to about 1150 m²/g, from about 45 m²/g to about 1100 m²/g, from about 50 m²/g to about 1050 m²/g, from about 55 m²/g to about 1000 m²/g, from about 60 m²/g to about 950 m²/g, from about 65 m²/g to about 900 m²/g, from about 70 m²/g to about 850 m²/g, from about 75 m²/g to about 800 m²/g, from about 80 m²/g to about 750 m²/g, from about 85 m²/g to about 700 m²/g, from about 90 m²/g to about 650 m²/g, from about 95 m²/g to about 600 m²/g, from about 100 m²/g to about 500 m²/g, from about 105 m²/g to about 450 m²/g, from about 110 m²/g to about 400 m²/g, from about 115 m²/g to about 350 m²/g, from about 120 m²/g to about 300 m²/g, from about 125 m²/g to about 250 m²/g. BET (Brunauer, Emmett, and Teller) surface area can be determined according to ASTM-D6556. In one embodiment, the oxidized carbon blacks are particulate. In one embodiment, carbon black or oxidized carbon black particles refers to the aggregate of primary particles and not to the primary particles themselves.

In one embodiment, the oxidized carbon blacks have an oil absorption number (OAN) ranging from about 35 to about 500 cm³/100 g, such as from about 50 to about 500 cm³/100 g, from about 75 to about 500 cm³/100 g, from about 100 to about 500 cm³/100 g, from about 35 to about 400 cm³/100 g, from about 50 to about 400 cm³/100 g, from about 75 to about 400 cm³/100 g, from about 100 to about 400 cm³/100 g, from about 35 to about 360 cm³/100 g, from about 50 to about 360 cm³/100 g, from about 75 to about 360 cm³/100 g, from about 100 to about 360 cm³/100 g, from about 35 to about 300 cm³/100 g, from about 50 to about 300 cm³/100 g, from about 75 to about 300 cm³/100 g, from about 100 to about 300 cm³/100 g, from about 35 to about 275 cm³/100 g, from about 50 to about 275 cm³/100 g, from about 75 to about 275 cm³/100 g, from about 100 to about 275 cm³/100 g, from about 35 to about 250 cm³/100 g, from about 50 to about 250 cm³/100 g, from about 75 to about 250 cm³/100 g, from about 100 to about 250 cm³/100 g, from about 35 to about 200 cm³/100 g, from about 50 to about 200 cm³/100 g, from about 75 to about 200 cm³/100 g, from about 100 to about 200 cm³/100 g, from about 35 to about 170 cm³/100 g, from about 50 to about 170 cm³/100 g, from about 75 to about 170 cm³/100 g, or from about 100 to about 170 cm³/100 g. OAN can be determined according to ASTM-D2414.

In one embodiment, the oxidized carbon blacks have a surface area ranging from about 5 to about 750 m²/g, such as from about 20 to about 650 m²/g, from about 50 to about 500 m²/g, or from about 100 to about 300 m²/g, and an OAN ranging from about 35 to about 170 mL/100 g, from about 50 to about 200 mL/100 g, from about 50 to about 170 mL/100 g, from about 100 to about 200 mL/100 g, or from about 100 to about 170 mL/100 g.

Also disclosed herein is an oxidized carbon black derived from a base carbon black. In one embodiment, the base carbon black has the following properties: a BET surface area ranging from about 5 to about 1500 m²/g; and an oil absorption number (OAN) ranging from about 35 to about 500 mL/100 g.

In one embodiment, the oxidized carbon black has a pH of about 6 or less, as determined by ASTM D1512. When oxidized carbon blacks are dispersed in water, the pH of the resulting supernatant is typically lowered due to increasing acid or phenol groups. In one embodiment, the oxidized carbon black has a pH ranging from about 1.5-6 or a pH ranging from about 2-6, as determined by ASTM D1512.

The oxidized carbon black can also be characterized from surface energy analysis (SEP) by measuring the water vapor adsorption using a gravimetric instrument (dynamic water vapor sorption method). In this method, the sample is weighed in a humidity chamber and allowed to equilibrate at a series of step changes in relative humidity while recording the change in mass. The equilibrium mass increase as a function of relative humidity can be used to generate the vapor sorption isotherm. Spreading pressure (in mJ/m²) for a sample is calculated as πₑ/BET, in which:

$${π}_{e} = RT {\int }_{0}^{{p}_{0}} Γ d ln p$$

and R is the ideal gas constant, T is temperature, Γ is moles of water adsorbed, p0 is the vapor pressure, and p is the partial pressure of the vapor at each incremental step. The spreading pressure is related to the surface energy of the solid and is indicative of the hydrophobic/hydrophilic properties of the solid, with a lower surface energy (SE) corresponding to a higher hydrophobicity. In one embodiment, the oxidized carbon black has a surface energy of at least about 25 mJ/m², such as a surface energy ranging from about 25 mJ/m² to about 70 mJ/m², from about 25 mJ/m² to about 60 mJ/m², or from about 25 mJ/m² to about 50 mJ/m².

The crystallite size of the oxidized carbon black can be determined by Raman spectroscopy, e.g., by monitoring two major “resonance” bands of a Raman spectrum at about 1340 cm−1 and 1580 cm−1, denoted as the “D” and “G” bands, respectively. The crystallite size (La) can be calculated in Angstroms from the equation:

$$La = 43.5 \times ( area of G band / area of D band ) .$$

In one embodiment, the oxidized carbon black has a crystallite size (La) of at least about 16 Å, as determined by Raman spectroscopy. In another embodiment, the oxidized carbon black has a crystallite size (La) ranging from about 16 Å to about 23 Å, as determined by Raman spectroscopy.

In one embodiment, the resistance of oxidized carbon black is characterized by its conductivity index, defined according to the following equation (see U.S. Pat. No. 6,820,738):

$$Conductivity Index = [ BET \times OAN ] 1 / 2 / [ 1 + volatile content ]$$

The conductivity index is dependent on the BET, OAN, and volatile content, which are described herein. The lower the BET and OAN, the lower the conductivity index and thus, the higher the resistance, whereas lower volatile content would lead to lower resistance of the oxidized carbon black.

In one embodiment, the oxidized carbon black has a conductivity index ranging from about 10 to about 75, from 1 about 5 to about 75, from about 20 to about 75, from about 25 to about 75, from about 10 to about 70, from about 15 to about 70, from about 20 to about 70, from about 25 to about 70, from about 10 to about 60, from about 15 to about 60, from about 20 to about 60, from about 25 to about 60, from about 10 to about 50, from about 15 to about 50, from about 20 to about 50, or from about 25 to about 50.

In another embodiment, the electrical resistance of the oxidized carbon black is characterized by its powder resistivity. In one embodiment, the powder resistivity is obtained at a defined compression by methods known in the art. Powder volume electrical resistivity can calculated at a certain pressure using the following equation:

$$ρ = R \times A / I$$

where ρ is the volume electrical resistivity (Ω-cm), R is the electrical resistance of the powder in (Ω), A is the cross sectional area of the cell (cm2), and I is the distance between two electrodes (cm).

In one embodiment, at a density of about 1.8 g/cm³, the oxidized carbon black has a powder resistivity of at least about 0.2 Ω-cm or at least about 0.25 Ω-cm, such as a powder resistivity ranging from about 0.2 to about 1.5 Ω-cm, from about 0.2 to about 1.4 Ω-cm, from about 0.2 to about 1.3 Ω-cm, from about 0.2 to about 1.2 Ω-cm, from about 0.2 to about 1.1 Ω-cm, from about 0.3 to about 1.5 Ω-cm, from about 0.3 to about 1.4 Ω-cm, from about 0.3 to about 1.3 Ω-cm, from about 0.3 to about 1.2 Ω-cm, or from about 0.3 to about 1.1 Ω-cm.

Oxidized carbon black can be produced according to a variety of methods. For instance, in one method carbon black powder is subjected to an oxidizing process that includes subjecting the carbon black to at least one agent selected from oxygen gas, ozone, nitrogen oxides of the formula NxOy where x=1-2 and y=1-4 (e.g., NO, NO₂, including mixtures with air), persulfates such as sodium, potassium, and ammonium persulfate, hypohalites such as sodium hypochlorite, halites, halates, perhalates such as sodium chlorite, sodium chlorate, or sodium perchlorate, oxidizing acids such as nitric acid, and transition metal-containing oxidants such as permanganate salts, osmium tetroxide, chromium oxides, ceric ammonium nitrates. In one embodiment, the at least one agent comprises at least two or more agents, e.g., oxygen and ozone, etc. In another embodiment, the oxidizing comprises subjecting the base carbon black to at least one agent that is mixed with air. Other suitable methods for producing an oxidized carbon black are provided in U.S. Pat. No. 3,398,009, which is incorporated herein by reference.

The conductive powder can include a lower structure carbon black. As used herein “lower structure” carbon black powders have small primary agglomerates and allow for dense packing of the carbon black material. A common test used to quantify low order structure is the absorption of dibutyl pthalate (DPB) oil, measured in cc's of oil absorbed per 100 grams of carbon black. Lower structure carbon blacks have a DPB absorption of about 125 cc/100 g carbon black or less.

Suitable oxidized carbon black includes oxidized Mogul E carbon blacks available from Cabot. Such oxidized carbon black powders include particles containing a carbon black particles having oxidized surfaces.

The polymer thick film composition can include from about 2 wt. % to about 10 wt. % of the conductive powder, such as from about 4 wt. % to about 9 wt. %, such as from about 3 wt. % to about 8 wt. %.

c. Resistivity

The polymer thick film PTC carbon resistor composition exhibits a resistivity of at least about 60,000 ohm/sq/25 μm when dried for a time of about 1 minute to about 24 hours at a temperature of about 90° C. to about 210° C. The polymer thick film PTC carbon resistor composition can be dried for a time and temperature so as to remove solvent (e.g., substantially all of the solvent) from the PTC carbon resistor composition. For instance, the composition can be dried such that at least 92 wt. %, such as at least 95 wt. %, such as at least 100 wt. % of the solvent has evaporated out of the polymer thick film PTC carbon resistor composition. In embodiments, the polymer thick film PTC carbon resistor composition can be applied to a surface and exposed to a process to remove the solvent from the composition. The process can include heating the composition at a temperature of about 90° C. to about 210° C., such as from about 100° to about 170° C., such as from about 120° C. to about 130° C. for a time of about 1 minute to about 24 hours. For instance, the heating time can range from about 1 minute to about 120 minutes, such as from about 20 minutes to about 60 minutes, such as from about 30 minutes to about 40 minutes, so as to remove the solvent from the composition.

In embodiments, after drying the composition exhibits a resistivity of about 75,000 ohm/sq/25 μm to about 1,000,000 ohm/sq/25 μm, such as from about 100,000 ohm/sq/25 μm to about 900,000 ohm/sq/25 μm, such as from about 200,000 ohm/sq/25 μm to about 800,000 ohm/sq/25 μm, such as from about 300,000 ohm/sq/25 μm to about 700,000, such as from about 400,000 to about 500,000 ohm/sq/25 μm.

### II. PTC Circuits and Articles

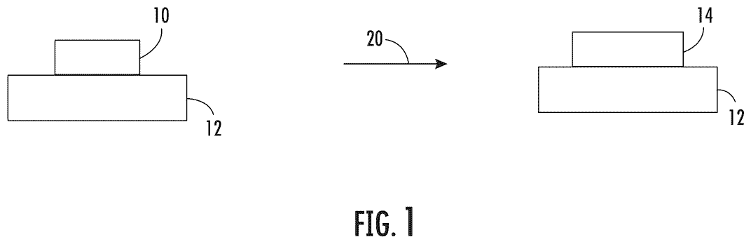

The polymer thick film PTC composition can be utilized to form PTC circuits on articles. For instance, the polymer thick film PTC carbon resistor composition can be applied to one or more substrates or components and utilized to form a circuit thereon. For instance, as shown in FIG. 1, the polymer thick film PTC composition 10 can be applied to a substrate 12. The polymer thick film PTC composition 10 can be applied to the substrate in any suitable manner including printing (e.g., screen printing). The substrate can be formed from any suitable material depending on the desired end use. For instance, the substrate can include glass materials (e.g., windshields, mirrors, windows etc.) plastic materials (e.g., plastic films, plastic coatings), or any other materials where a PTC circuit is desired. The substrate can include other components thereon, such as conductors disposed on the surface of the substrate. Further, the polymer thick film PTC composition 10 can be used in applications where high voltages (e.g., greater than 300 V) are required. At 20, the polymer thick film PTC composition 10 is dried forming a PTC circuit 14 on the substrate 12. The PTC circuit 14 has a resistivity of at least about 65,000 ohm/sq/25 μm up to about 1,000,000 ohm/sq/25 μm. In embodiments, the polymer thick film PTC composition 10 can be used to form a PTC circuit on a heating film for an electric vehicle battery.

Articles that can be formed including the PTC circuit 14 can include heating films (e.g., heating films for electric vehicle batteries), mirror heaters, seat heaters, windshield heaters, etc.

### III. Methods

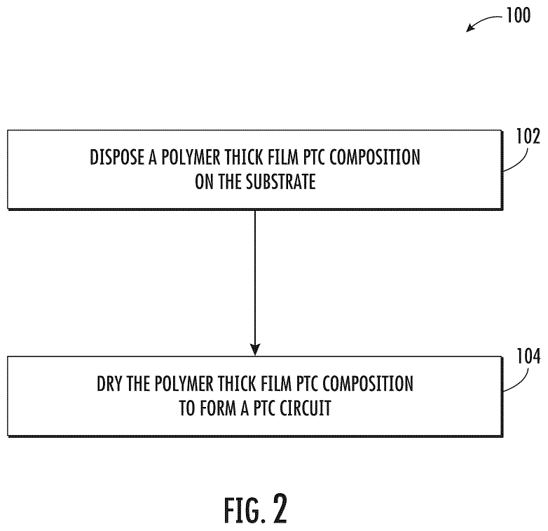

FIG. 2 depicts a flow diagram of one example method of forming an article (100) according to the present disclosure.

At (102), the method includes disposing a polymer thick film PTC composition on a substrate. The polymer thick film PTC composition can include a conductive material and an organic medium, including a polymer dissolved in a solvent. The polymer thick film PTC composition can include materials described hereinabove. In embodiments, the conductive material includes an oxidized carbon powder, such as an oxidized carbon black powder. The polymer can include a fluoropolymer and the solvent can include a trialkyl phosphate and/or an amide. The polymer thick film PTC composition can include from about 1 wt. % to about 10 wt. % of the conductive powder and from about 85 wt. % to about 95 wt. % of the organic medium.

The substrate can include a multi-material substrate. For instance, the substrate can be formed from a suitable substrate material having a conductor thereon. The substrate can be formed from one or more thermoplastic or thermoformed materials. The conductor can be formed from one or more conductive pastes having conductive particles (e.g., metal particles) dispersed therein. The polymer thick film PTC composition can be disposed over at least a portion of the conductor to form the article. In other embodiments, the polymer thick film PTC composition can be disposed over at least a portion of a first conductor and a second conductor to form the article. The PTC composition can be disposed over a plurality of conductors.

At (104), the method includes drying the polymer thick film PTC composition to form a PTC circuit. The substrate and polymer thick film PTC composition can be placed in any suitable oven (e.g., box oven) and dried. In embodiments, the drying time can range from about 1 minute to about 60 minutes, such as from about 20 minutes to about 50 minutes, such as from about 30 minutes to about 40 minutes. The drying temperature can range from about 90° C. to about 210° C., such as from about 90° C. to about 180° C., such as from about 100° C. to about 150° C. The drying temperature can also be increased and decreased incrementally as needed to dry the PTC composition.

Drying of the polymer thick film PTC composition can also be executed in a convection belt drier. In such embodiments, the drying time can be from about 1 minute to about 1 hour, such as 1 minute to about 20 minutes, such as about 1 minute to about 10 minutes. In certain embodiments, the drying time in the convection belt drier can be from about 1 minute to about 3 minutes.

### EXAMPLES 1-2

The present disclosure is further illustrated by, but is not limited to, the following examples.

Example polymer thick film PTC carbon resistor compositions were formed according to Table 1.

TABLE 1

| | | | Comparative |
|---|---|---|---|
| | Example 1 | Example 2 | Example 1 |
| Description | (wt. %) | (wt. %) | (wt. %) |
| Oxidized Carbon Black | 7.76 | 6.87 | 0 |
| Carbon Black | 0 | 0 | 7.63 |
| Polymer - PVDF | 34.13 | 30.26 | 34.18 |
| copolymer with HFP | | | |
| Tetramethyl Urea | 58.11 | 0 | 58.19 |
| Triethyl phosphate | 0 | 62.87 | 0 |
| Total | 100 | 100 | 100 |
| Resistivity | 355,000 | 650,000 | 5,000 |

A polymer thick film PTC carbon resistor composition (paste) of Example 1 was prepared by first preparing the organic medium as follows: 37 wt. % copolymer of vinylidene fluoride and hexafluoropropylene resin (Kynar® ADS® II Arkema Inc. King of Prussia, PA) was mixed with 63 wt. % tetramethyl urea organic solvent. The above mixture was heated at 90° C. for 1-2 hours to dissolve all the resin and form the organic medium. Oxidized conductive carbon black Mogul® E (Cabot Corp. Boston, Mass) was then added to the organic medium. The polymer thick film PTC carbon resistor composition was: 7.76 wt. % carbon black and 92.24 wt. % organic medium (34.13 wt. % copolymer and 58.11 wt. % solvent).

The composition was mixed for 30 minutes on a planetary mixer. The composition was then transferred to a three-roll mill where it was subjected to one pass at 0 psi and one pass at 150 psi. The result was a polymer thick film PTC carbon resistor composition.

For Example 2, a polymer thick film PTC composition was produced essentially as described above in Example 1. However, the amounts of carbon black, copolymer, and solvent differ as shown. Similarly, for Comparative Example 1, a polymer thick film PTC composition was produced as described above in Example 1, with amounts varying based on those shown in Table 1. Also, a different type of carbon black powder that was not oxidized was used.

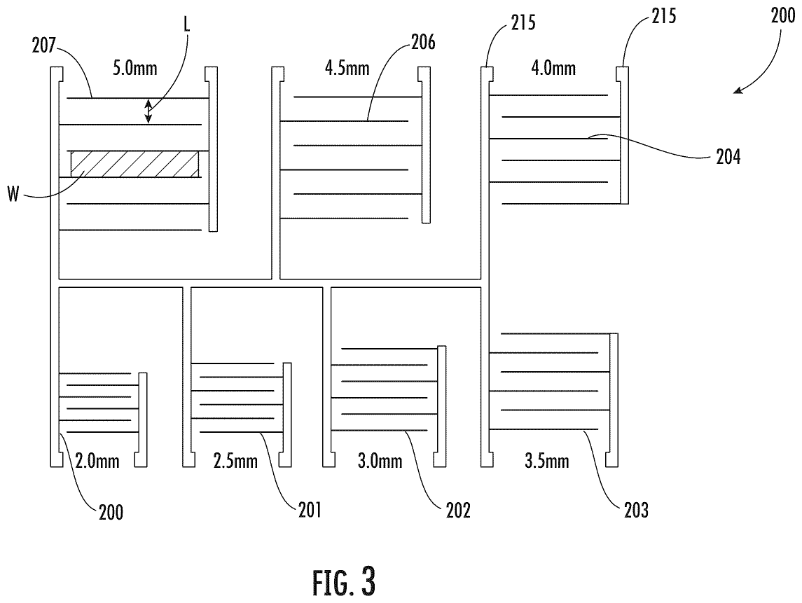

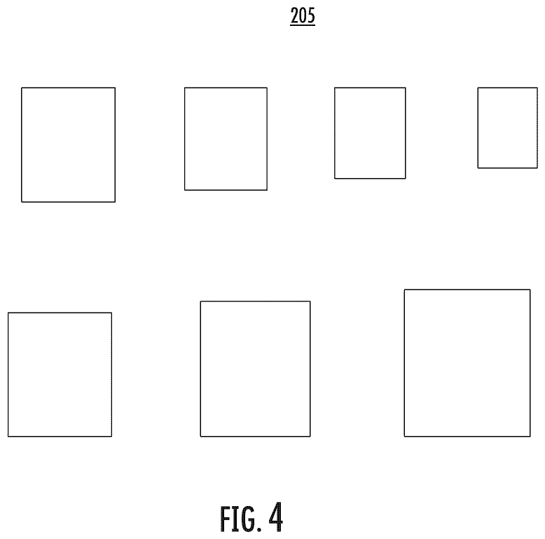

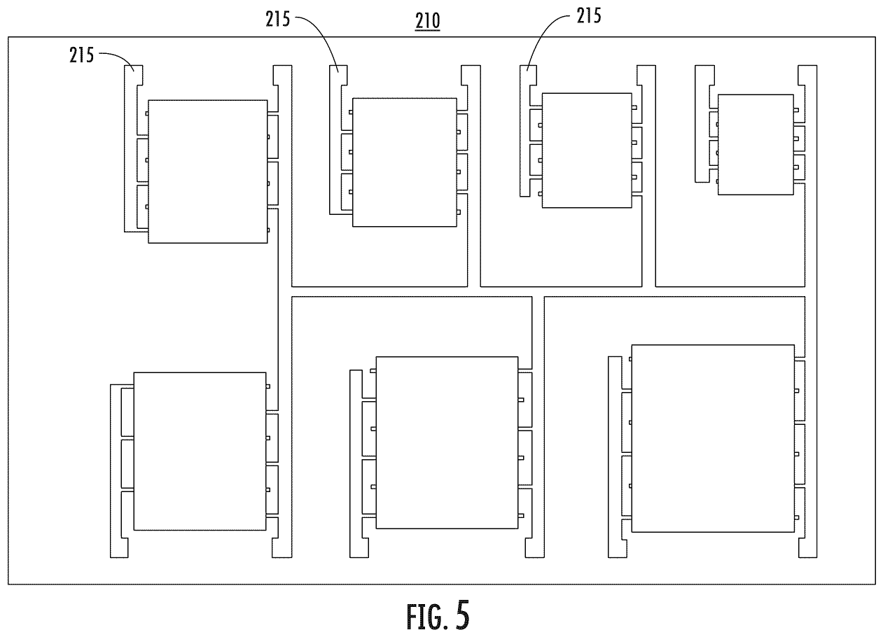

To test the resistivity of the Examples and Comparative Example 1, a 12×12 feet screen was used. Using a 325 mesh/28 μm stainless steel screen, a series of interdigitated silver lines were printed on a polyethylene terephthalate substrate using DuPont 5064 silver conductive ink (DuPont Co., Wilmington, DE). The silver lines were printed according to pattern 200 as depicted in FIG. 3. The silver conductor was dried at 140° C. for 15 minutes in a forced air box oven. Next, using a 200 mesh/40 μm stainless steel screen, PTC circuit pads were printed over each of the interdigitated patterns in sizes ranging from 2.0 mm, 2.5 mm, 3.0 mm, 3.5 mm, 4.0 mm, 4.5 mm, and 5.0 mm. The PTC circuit pad pattern 205 is depicted in FIG. 4. This resulted in seven carbon pads in each print. Each circuit pad is a different size depending on the size of the resistor. The pattern 210 having the PTC circuit pads printed over the silver pattern is shown in FIG. 5.

Resistance of cyclic patters was measured with a Fluke 45 Dual Display Multimeter and was measured in ohms. The multimeter pads were placed on the pads 215 of the pattern as indicated in FIG. 5

The thickness of the PTC carbon layer was measured using an Ono Sokki. The Ono Sokki was zeroed out by placing the probe on an empty area of the PET substrate and hitting zero. The probe was then placed on the PTC carbon layer and avoiding the silver underlining. Once resistance and thickness were measured, resistivity was then tested and calculated according to the following.

$$Rs = R ( Th / 25.4 ) ( W * N / L )$$

where, L was the length of the current flow; W was the width of the current flow; and N equaled the number of parallel resistors. Here the width W and length L are shown in FIG. 3. The width W corresponds to the shaded area between each of the interdigitated lines and the Length L corresponds to the distance between each interdigitated line. As shown in FIG. 3, the number N of parallel resistors was 5. As illustrated in FIG. 3, each of the resistors has a different length L between each of the interdigitated lines. For instance, the first resistor 200 has an L of 2.0 mm, the second resistor 201 has an L of 2.5 mm, the third resistor 202 has an L of 3.0 mm, the fourth resistor 203 has an L of 3.5 mm, the fifth resistor 204 has an L of 4.0, the sixth resistor 206 has an L of 4.5 mm, and the seventh resistor 207 has an L of 5.0 mm. As depicted in Table 1 above, the Example formulations have significantly higher resistivity as compared to the Comparative Example 1.

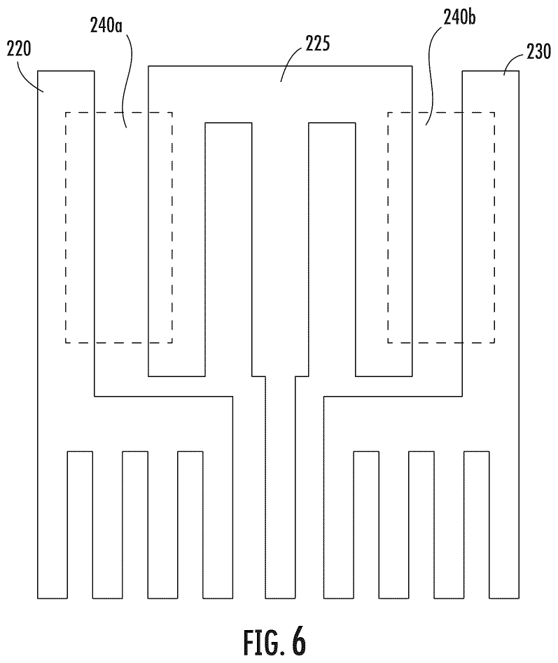

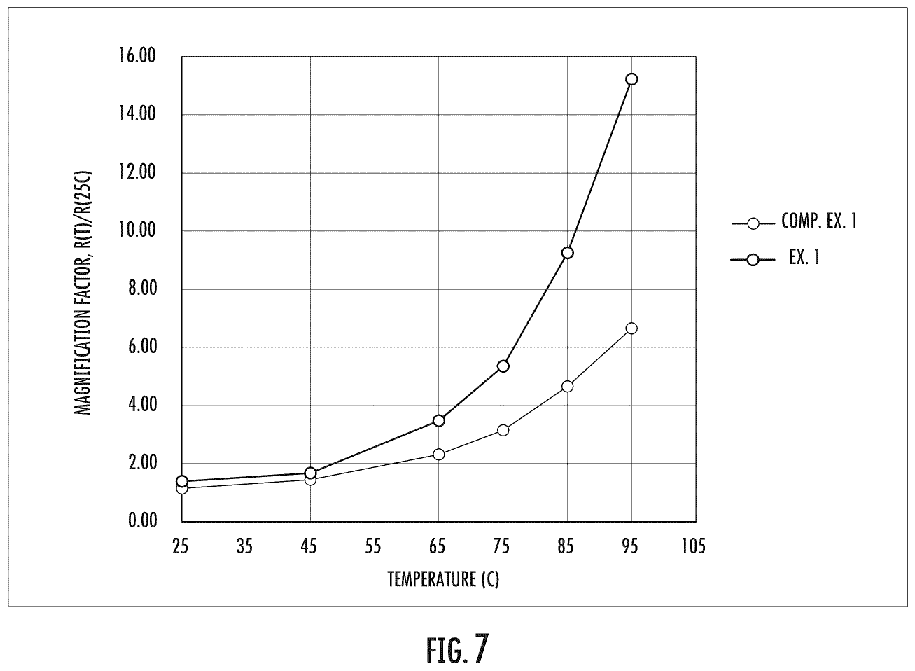

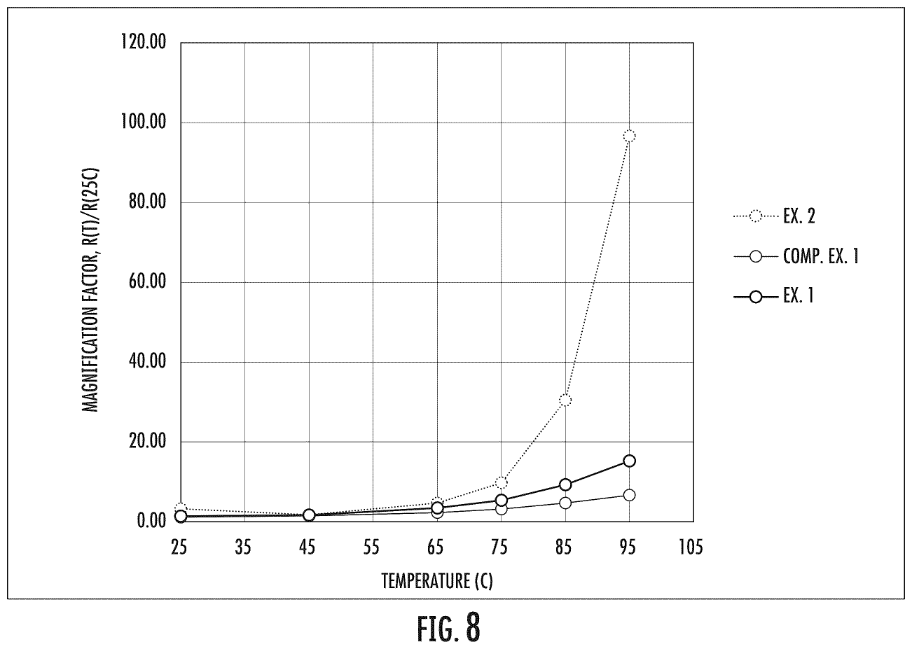

PTC curves were then created for Example 1 and Comparative Example 1. The resistor design for testing of the PTC curves included two resistors in parallel having a width of 2.5 mm and a length of 12.5 mm. The resistor design is illustrated in FIG. 6. As shown, a first circuit 220, second circuit 225, and a third circuit 230, were fabricated as follows: using a 325 mesh/28 μm stainless steel screen, a series of interdigitated silver lines were printed on a polyethylene terephthalate substrate using DuPont 5064 silver conductive ink (Dupont Co., Wilmington, DE). The first circuit 220, second circuit 225, and third circuit 230 including silver conductors were dried at 140° C. for 15 minutes in a forced air box oven. Next, the PTC circuit pattern 240a and 240b were provided. PTC circuit pattern 225a overlapped at least partially with the first circuit 220 and the second circuit 225. PTC circuit pattern 240b overlapped at least partially with the second circuit 225 and the third circuit 230. The above polymer thick film PTC carbon resistor composition was printed at least partially on top of the silver conductors as shown and described. The PTC carbon resistor compositions were printed using a 200 mesh/40 μm stainless steel screen. The PTC carbon resistor composition was then dried at 130° C. for 20 minutes in a forced air box oven to form a first PTC circuit and a second PTC circuit. The temperature coefficient of resistance (TCR) for Example 1 and Comparative Example 1 were then tested by placing the resistors in a TCR chamber. The resistors were placed in a Suanders and Associates Model 4220 temperature test chamber. The resistors were loaded into each slot of the chamber along with two alumina spacer to ensure a good connection to the chamber. The resistivity can then be calculated according to the above equation using the resistance value at each temperature. The Ono Sokki method disclosed above was used to test the thickness of the PTC carbon layer. The magnification factor was calculated according to the following: R(T)/R (25° C. original). PTC curves are provided in FIGS. 7-8.

As illustrated, the PTC circuits utilizing the Example 1 paste exhibited a higher magnification factor and also exhibited PTC effect that was more sensitive to temperature change as compared to Comparative Example 1.

### DEFINITIONS

As used herein, ranges and amounts can be expressed as “about” a particular value or range. “About” is intended to also include the exact amount. Hence “about 5 percent” means “about 5 percent” and also “5 percent.” “About” means within typical experimental error for the application or purpose intended.

As used herein, “optional” or “optionally” means that the subsequently described event or circumstance does or does not occur, and that the description includes instances where said event or circumstance occurs and instances where it does not. For example, an optional component in a method or composition means that the component may be present or may not be present in the method or composition.

As used herein, the term “substantially free” means no more than an insignificant trace amount present and encompasses completely free (e.g., 0 molar % up to 0.01 molar %).

Chemical elements are discussed in the present disclosure using their common chemical abbreviation, such as commonly found on a periodic table of elements. For example, hydrogen is represented by its common chemical abbreviation H; helium is represented by its common chemical abbreviation He; and so forth.

All references to singular characteristics or limitations of the present disclosure shall include the corresponding plural characteristic or limitation, and vice versa, unless otherwise specified or clearly implied to the contrary by the context in which the reference is made.

The methods and compositions of the present disclosure, including components thereof, can comprise, consist of, or consist essentially of the essential elements and limitations of the disclosure described herein.

These and other modifications and variations of the present disclosure may be practiced by those of ordinary skill in the art, without departing from the spirit and scope of the present disclosure. In addition, it should be understood that aspects of the various embodiments may be interchanged both in whole or in part. Furthermore, those of ordinary skill in the art will appreciate that the foregoing description is by way of example only and is not intended to limit the disclosure so further described in such appended claims.

1. A polymer thick film positive temperature coefficient carbon resistor composition, comprising:
an organic medium comprising a fluoropolymer resin and an organic solvent; and
conductive carbon powder;
wherein the composition exhibits a resistivity of at least 65,000 ohm/sq/25 μm when dried for a time of about 1 minute to about 24 hours at a temperature of about 90° C. to about 210° C.

2. The composition of claim 1, wherein the composition exhibits a resistivity of at least 100,000 ohm/sq/25 μm up to about 1,000,000 ohm/sq/25 μm.

3. The composition of claim 1, wherein the composition exhibits a resistivity of at least about 250,000 ohm/sq/25 μm to about 800,000 ohm/sq/25 μm.

4. The composition of claim 1, wherein the fluoropolymer resin comprises a copolymer of vinylidene difluoride and hexafluoropropylene.

5. The composition of claim 1, wherein the organic solvent comprises one or more trialkyl phosphates, tetraethyl urea, or a combination thereof.

6. The composition of claim 5, wherein a ratio of the trialkyl phosphate to the tetraethyl urea is about 5:1 to about 12:1.

7. The composition of claim 1, wherein the conductive powder comprises an oxidized carbon black.

8. The composition of claim 7, wherein the oxidized carbon black has a total oxygen content of at least about 0.1 wt. % to about 15 wt. % based on the total weight of the oxidized carbon black as determined by inert gas fusion.

9. The composition of claim 7, wherein the oxidized carbon black has a BET surface area of about 5 m²/g to about 1500 m²/g as determined in accordance with ASTM-D6556.

10. The composition of claim 7, wherein the oxidized carbon black has an oil absorption number (OAN) ranging from 35 cm³/100 g to 500 cm³/100 g as determined in accordance with ASTM-D2414.

11. The composition of claim 7, wherein the oxidized carbon black has a volatile content ranging from about 0.1 wt. % to about 25 wt. % relative to the total weight of the oxidized carbon black, as determined by weight loss at 950° C.

12. The composition of claim 1, wherein the conductive carbon powder is present in an amount of about 2 wt. % to about 20 wt. %.

13. A positive temperature coefficient circuit comprising the polymer thick film positive temperature coefficient carbon resistor composition of claim 1, wherein the polymer thick film positive temperature coefficient carbon resistor composition has been dried to remove the organic solvent.

14. The positive temperature coefficient circuit of claim 13, wherein the composition exhibits a resistivity of at least 250,000 ohm/sq/25 μm up to about 1,000,000 ohm/sq/25 μm.

15. The positive temperature coefficient circuit of claim 13, wherein the composition exhibits a resistivity of at least 500,000 ohm/sq/25 μm up to about 1,000,000 ohm/sq/25 μm.

16. The positive temperature coefficient circuit of claim 13, wherein the fluoropolymer resin comprises a copolymer of vinylidene difluoride and hexafluoropropylene.

17. The positive temperature coefficient circuit of claim 13, wherein the oxidized carbon powder comprises an oxidized carbon black.

18. The positive temperature coefficient circuit of claim 17, wherein the oxidized carbon black has at least one of the following:
(a) a total oxygen content of at least about 0.1 wt. % to about 15 wt. % based on the total weight of the oxidized carbon black as determined by inert gas fusion;
(b) a BET surface area of about 5 m²/g to about 1500 m²/g as determined in accordance with ASTM-D6556;
(c) an oil absorption number (OAN) ranging from 35 cm³/100 g to 500 cm³/100 g as determined in accordance with ASTM-D2414; or
(d) has a surface area ranging from about 5 m²/g to about 750 m²/g.

19. An article comprising the positive temperature coefficient circuit of claim 13.

20. A method for forming a PTC circuit, the method comprising:
depositing a polymer thick film positive temperature coefficient carbon resistor composition on a substrate, the polymer thick film positive temperature coefficient carbon resistor composition comprising an organic medium comprising a fluoropolymer resin and an organic solvent, and an oxidized carbon black, the oxidized carbon black comprising at least one of the following:
(a) a total oxygen content of at least about 0.1 wt. % to about 15 wt. % based on the total weight of the oxidized carbon black as determined by inert gas fusion;
(b) a BET surface area of about 5 m²/g to about 1500 m²/g as determined in accordance with ASTM-D6556;
(c) an oil absorption number (OAN) ranging from 35 cm³/100 g to 500 cm³/100 g as determined in accordance with ASTM-D2414; or
(d) has a surface area ranging from about 5 m²/g to about 750 m²/g; and
drying the positive temperature coefficient composition for a time of about 1 minute to about 60 minutes at a temperature of about 90° C. to about 210° C. to form a positive temperature coefficient circuit on the substrate, wherein the positive temperature coefficient circuit has a resistivity of at least 65,000 ohm/sq/25 μm.
